(19) United States
(12) Patent Application Publication
(10) Pub. No.: US 2015/0112762 A1
(43) Pub. Date: Apr. 23, 2015

(54) OPTIMIZATION OF PRODUCT ASSORTMENTS

(71) Applicant: Target Brands, Inc., Minneapolis, MN (US)

(72) Inventors: Maher Lahmar, Minneapolis, MN (US); Diptesh Basak, Bangalore (IN); Somsubhra Sikdar, Bangalore (IN); Abhishek Singh Verma, Bangalore (IN)

(73) Assignee: Target Brands, Inc., Minneapolis, MN (US)

(21) Appl. No.: 14/057,461

(22) Filed: Oct. 18, 2013

(51) Int. Cl. G06Q 30/02

(52) U.S. Cl. CPC G06Q 30/0202
USPC 705/7.31

(57) ABSTRACT

A system analyzes past sales data to identify those product assortments that may lead to the largest sales volume for the product category. The system estimates an incremental sales volume increase associated with each of one or more product assortments. The system may further identify which assortment will result in the largest sales volume for the product category, and may generate a ranking of the one or more assortments based on their associated incremental sales volume increase.

### TECHNICAL FIELD

This disclosure generally relates to techniques for optimizing product assortments.

### BACKGROUND

Big box retail stores may stock and sell a wide variety of products and may cater to large customer demands. Regardless of the type of store, offering the right mix of products is important to the store's long-term success and customer satisfaction. Product assortment optimization involves strategic inventory decisions and product selection, the goal of which is to maximize profit, minimize risk, and increase overall sales. As the physical size and number of products offered by retail stores increase, the selection of products within such stores is becoming a more relevant, complex, and intricate inquiry.

### SUMMARY

This disclosure relates generally to techniques for optimizing product assortments at retail stores or other business establishments.

In one example, the disclosure is directed to a method comprising receiving, by a computing device, past sales data associated with a plurality of stores, identifying a reference assortment including a first plurality of items, identifying one or more additional items that are not included in the first plurality of items, determining average sales for the reference assortment over a predetermined period of time based on the past sales data, determining average sales for each of one or more new assortments over the predetermined period of time based on the past sales data, each new assortment including the first plurality of items and one or more of the additional items, estimating an incremental sales volume increase associated with each of the one or more new assortments, each estimation based on the average sales for the reference assortment and the average sales for the associated new assortment, identifying which of the one or more new assortments results in the largest incremental sales volume increase, and generating one or more reports indicative of the identified new assortment that results in the largest incremental sales volume increase. The method may further include including testing the estimated incremental sales volume increase associated with each of the one or more new assortments against one or more incremental sales volume rules. The one or more incremental sales volume rules may be based on at least one of a number of items in the reference assortment, a number of additional items added to the reference assortment, and a sequence in which the one or more additional items are added to the reference assortment.

In another example, the disclosure is directed to a device comprising a computer-readable storage medium, at least one processor configured to access information stored on the computer- readable storage medium, and an assortment optimization module stored on the computer-readable storage medium and accessible by the at least one processor, the assortment optimization module configured to receive past sales data associated with a plurality of stores, identify a reference assortment including a first plurality of items, identify one or more additional items that are not included in the first plurality of items, determine average sales for the reference assortment over a predetermined period of time based on the past sales data, determine average sales for each of one or more new assortments over the predetermined period of time based on the past sales data, each new assortment including the first plurality of items and one or more of the additional items, estimate an incremental sales volume increase associated with each of the one or more new assortments, each estimation based on the average sales for the reference assortment and the average sales for the associated new assortment, identify which of the one or more new assortments results in the largest incremental sales volume increase, and generate one or more reports indicative of the identified new assortment that results in the largest incremental sales volume increase.

In another example, the disclosure is directed to A non-transitory computer-readable storage medium encoded with instructions that, when executed by one or more processors, cause the one or more processors of a computing device to receive, by a computing device, past sales data associated with a plurality of stores, identify a reference assortment including a first plurality of items, identify one or more additional items that are not included in the first plurality of items, determine average sales for the reference assortment over a predetermined period of time based on the past sales data, determine average sales for each of one or more new assortments over the predetermined period of time based on the past sales data, each new assortment including the first plurality of items and one or more of the additional items, estimate an incremental sales volume increase associated with each of the one or more new assortments, each estimation based on the average sales for the reference assortment and the average sales for the associated new assortment, identify which of the one or more new assortments results in the largest incremental sales volume increase, and generate one or more reports indicative of the identified new assortment that results in the largest incremental sales volume increase.

The details of one or more examples are set forth in the accompanying drawings and the description below. Other features and advantages according to this disclosure will be apparent from the description and drawings, and from the claims.

### BRIEF DESCRIPTION OF DRAWINGS

FIG. 1 is a conceptual block diagram illustrating a system that optimizes product assortments in accordance with the techniques of this disclosure.

FIG. 2 is a conceptual diagram illustrating adding items to and removing items from an assortment.

FIG. 3 includes tables illustrating aggregation of assortment sales volume data.

FIG. 4 includes tables illustrating calculation of average normalized sales data for an assortment.

FIG. 5 is a conceptual diagram illustrating a first example incremental sales volume rule.

FIG. 6 is a conceptual diagram illustrating a second example incremental sales volume rule.

FIG. 7 is a conceptual diagram illustrating a third example incremental sales volume rule.

FIG. 8 is a conceptual diagram illustrating a fourth example incremental sales volume rule.

FIG. 9 is a flowchart illustrating an example process for determining an assortment of items that results in an incremental sales volume increase.

### DETAILED DESCRIPTION

This disclosure relates generally to techniques for optimization of product assortments at retail stores or other business establishments. Retailers, for example, may offer a number of product varieties within each product category. The varieties offered within each product category may be referred to as an “assortment.” The techniques of this disclosure analyze sales data from one or more stores to estimate an incremental sales volume increase (“incrementality”) associated with adding one or more items to an assortment. The incrementality of adding one or more items to the assortment is indicative of a change in sales associated with adding the one or more items to the assortment. Based on the incrementalities associated with adding one or more items to an assortment, assortments that may result in increased total sales for the category may be identified.

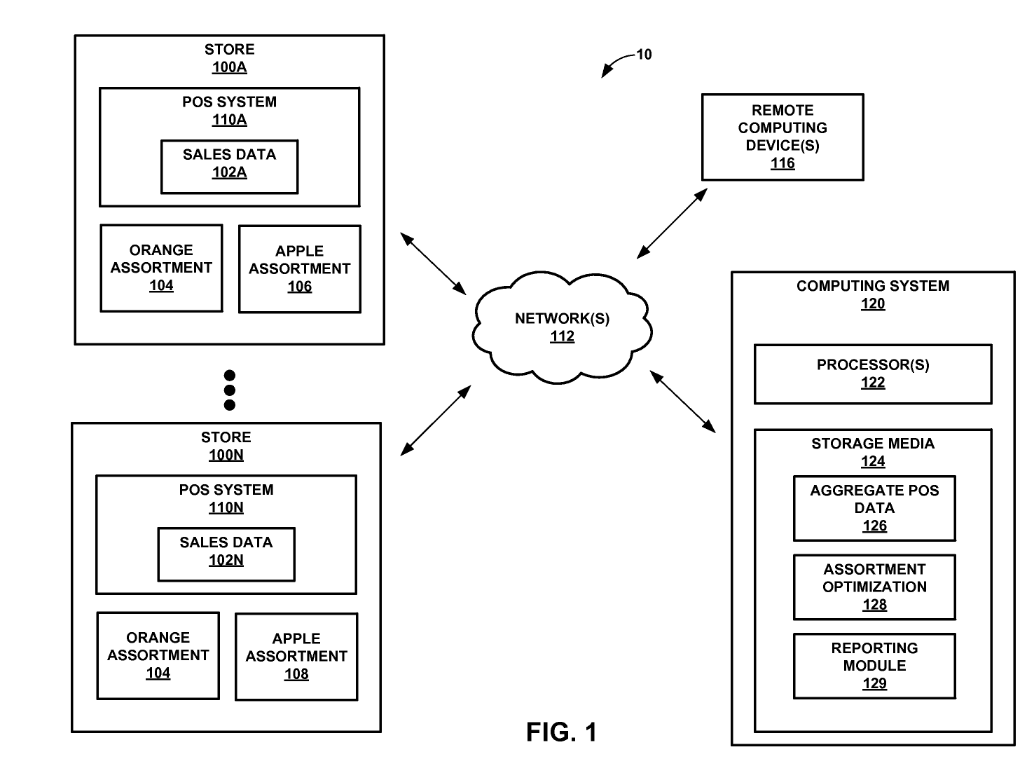

FIG. 1 is a conceptual block diagram illustrating a system 10 that optimizes product assortments in accordance with the techniques of this disclosure. A plurality of retail stores 100A-100N each includes a point of sale (POS) system 110A-110N, respectively. Each POS system 110A-110N includes storage media capable of storing sales data 102A-102N on a temporary or permanent basis for the associated store. Each POS system 110A-110N may also include POS terminals at checkout locations within the stores. When a UPC of an item is scanned at checkout and paid for by a customer, the POS terminal may record data indicating that the item has been sold, as well as information about the date and time that time the item was sold, the item price, information associating the particular customer with the purchased item, and other relevant information associated with the sale.

Each POS system 110A-110N may provide further functionality such as inventory control, purchasing, receiving, and transferring of products to and from other locations. The POS systems 110A-110N may further store customer information, analyze sales data, and/or generate financial reports for the stores, as well as provide other functionality relevant to the retail operation.

Each of stores 100A-100N offers a plurality of products for sale. Each of these products may include an assortment of one or more varieties. In FIG. 1, for example, store 100A offers an assortment of oranges 104 and an assortment of apples 106. Store 100N offers the same assortment of oranges 104 and a different assortment of apples 108. Orange assortment 104 may include, for example, the varieties Cara Cara, Navel, and Valencia. Apple assortment 106 offered by store 100A may include, for example, the varieties Honeycrisp, Red Delicious, Braeburn, and Granny Smith, while apple assortment 108 offered by store 100N may include the varieties Honeycrisp, Pink Lady, and Gala. Although for purposes of illustration FIG. 1 shows assortments of apples and oranges, it shall be understood that the disclosure is applicable to assortment optimization for any product, whether it be produce items, grocery items, toys, clothing, hardware, housewares, cleaning products, furniture, pharmacy, or any other product that may be offered in a retail environment. To that end, each of stores 100A-100N will include an assortment of one or more items for each product category in the store.

System 10 further includes a computing system 120 and one or more remote computing device(s) 116. POS systems 110A-110N, computing system 120, and/or remote computing device(s) 116 may be communicatively coupled via one or more network(s) 112. Network(s) 24 may include, for example, one or more of a dial-up connection, a local area network (LAN), a wide area network (WAN), the internet, a cellular telephone network, satellite communication, or other means of electronic communication. The network(s) 112 may be wired or wireless. Computing system 120 may send commands, instructions, software updates, etc. to stores 110A-100N via network(s) 112. Computing system 120 may receive data or otherwise communicate with the stores on a periodic basis, in real-time, upon request, or at any other appropriate time.

Computing system 120 includes one or more processors 122 and storage media 124 accessible by processors 122 or other computing devices. Computing system 120 may receive sales data 102A-102N from stores 100A-100N and store that sales data as aggregate POS data 126. Computing system 120 also includes an assortment optimization module 128. Assortment optimization module 128 includes computer-readable instructions that, when executed by processor(s) 122 or other computing device, carry out one of more of the assortment optimization techniques described herein. For example, assortment optimization module 128 may analyze the sales data from one or more of stores 100A-100N to determine an incremental sales volume increase associated with adding one or more items to a product assortment.

For purposes of the present disclosure, “sales volume” refers to the dollar amount a business makes during a given period of time. “Unit sales” refers to the quantity of items a business sells during a given period. The concepts of “sales volume” and “unit sales” are related in that the total sales volume equal unit sales multiplied by the unit price.

Computing system 120 may also include a reporting module 129. Reporting module 129 may generate one or more reports that present the analysis performed by assortment optimization module 128. These reports may be used by the person(s) responsible for determining the product assortments to be offered at one or more of stores 100A-100N. For example, a user of one of remote computing device(s) 116 may request and/or receive reports indicative of the incremental sales volume increases associated with adding one or more items to a product assortment. This information may assist the user in determining which product assortments to offer at one or more of stores 100A-100N.

Computing system 120 may comprise one or more processors, servers, tablets, desktop computers, mainframes, cloud-based servers, virtual machines, or any other computing device. Storage media 124 may include one or more storage media accessible by processor(s) 122 or other computing device(s). Storage media 124 may include one or more object-relational databases, or other data management systems. In addition to sales data 102A-102N for each of stores 100A-100N, aggregate POS data 126 may include additional data associated with stores 100A-100N.

In accordance with the techniques of this disclosure, computing system 120, executing instructions of assortment optimization module 128, may determine an incremental unit sales volume increase (“incrementality”) associated with adding one or more items to a product assortment. Computing system 120, executing instructions of assortment optimization module 128, may further test each of the incremental unit sales volume increases against one or more incremental sales volume rules. The incremental sales volume rules may define a relative impact on sales of the assortment of items resulting from adding the different combinations of the plurality of additional items to the assortment. The plurality of incremental sales volume rules may be based on at least one of a number of items in a reference assortment, a number of additional items added to the assortment, and a sequence in which multiple items are added to the assortment.

Computing system 120, executing instructions of assortment optimization module 128, may further identify an assortment with a largest incremental unit sales volume increase, identify an assortment with a smallest incremental unit sales volume increase, and/or rank two or more assortments in terms of their incremental unit sales volume increase. Assortment optimization module 128 may also include other functionality relevant to optimization of product assortments.

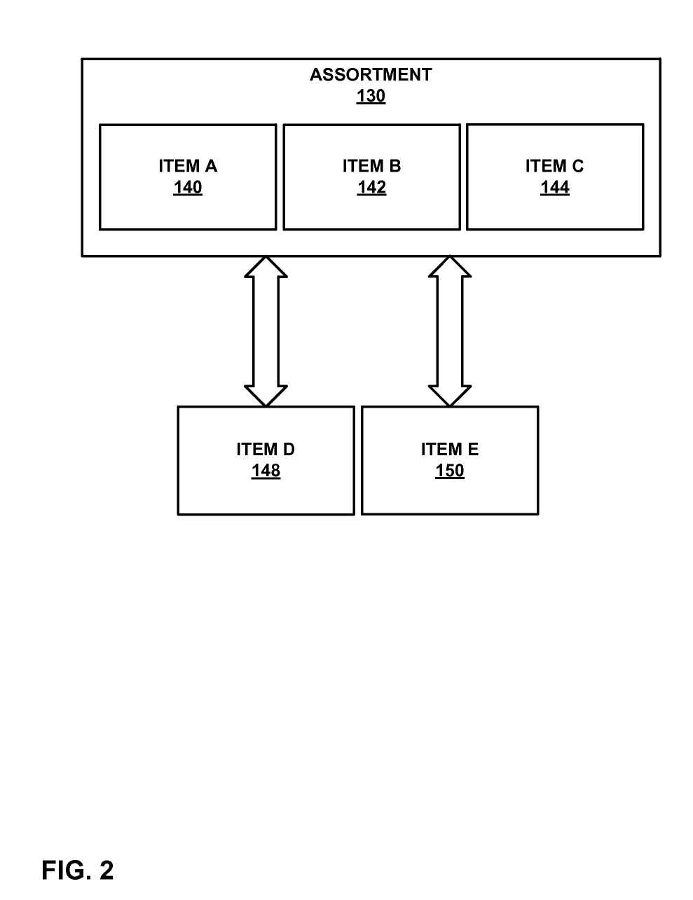

FIG. 2 is a conceptual diagram illustrating modifying an assortment by substituting one or more varieties, also referred to as “items,” in an assortment 120 with one or more items that are not part of the original assortment. Assortment 120 includes item A 140, item B 142, and item C 144. Item D148 and item E 150, which are not part of original assortment 120, may be added to assortment 120 in several ways. For example, item D 148 or item E 150 may be added individually. For example, item D 148 may be added to assortment 120, resulting in assortment ABCD, and then item E 150 may be added to assortment 120, resulting in assortment ABCDE. As another example, item E 150 may be added to assortment 120, resulting in assortment ABCE, and then item D may be added to assortment 120, resulting in assortment ABCDE. Alternatively, item D 148 and item E 150 may be added to original assortment ABC 120 at the same time, resulting in assortment ABCDE. The incremental sales volume increase (“incrementality”) associated with adding one or more items to assortment 120 may be determined for each of these combinations, as well as for any other relevant combinations. For example, the incrementality of adding item D to assortment ABC may be determined; the incrementality of adding item E to assortment ABC may be determined; the incrementality of adding items D and E at the same time to assortment ABC may be determined; the incrementality of adding item E to assortment ABCD may be determined; the incrementality of adding item D to assortment ABCE may be determined; etc. Based on the determined incrementalities, computing system 120 may identify one or more assortments that maximizes the sales volume for the category.

In some examples, due to the nature of empirical estimations of item incrementalities, variation across assortment and items may lead to irrational relationships. To address this, computing system 120 may apply an optimization smoothing model to the estimated incrementalities. For example, the optimization smoothing model may test the item incrementalities for each assortment against one or more incremental sales volume rules. The one or more incremental sales volume rules may define a relative impact on sales of an assortment resulting from adding the different combinations of the plurality of additional items to an assortment. The plurality of incremental sales volume rules is based on at least one of a number of items in the original assortment, a number of additional items added to the assortment, an order of adding at least two of the additional items to the assortment, and any other relevant factors. The optimization model may further adjust the item incrementalities if they violate one or more of the plurality of incremental sales volume rules. Examples of the optimization models and the incremental sales volume rules will be discussed in further detail below.

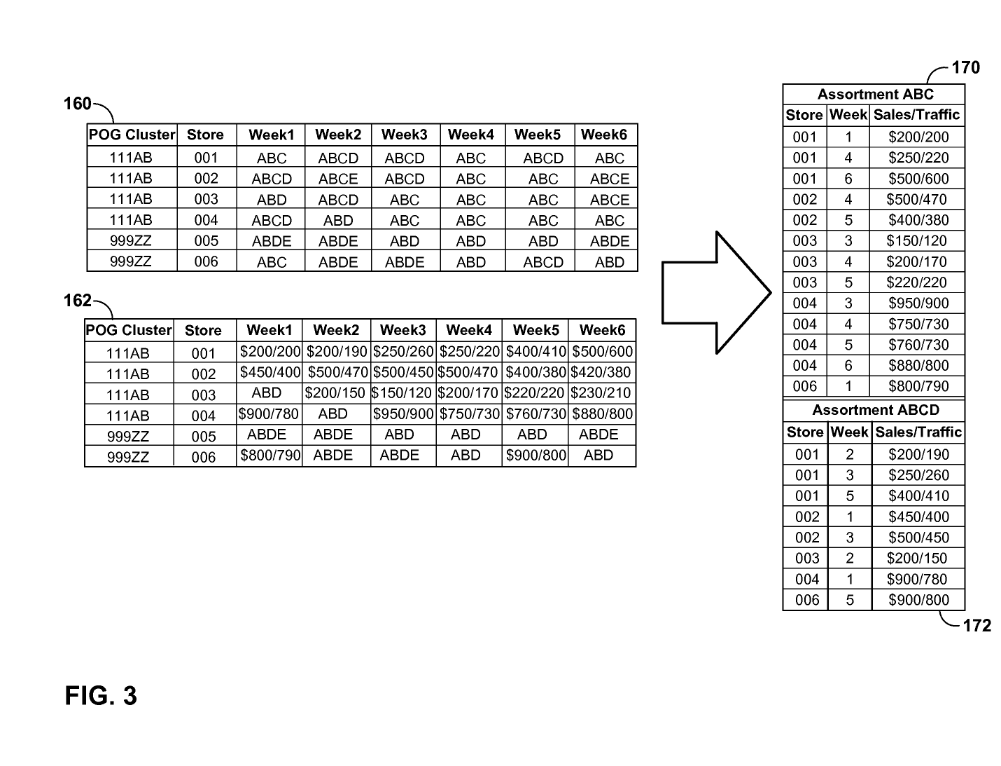

FIG. 3 are tables illustrating example sales data for various product assortments. Table 160 and a Table 162 include example sales data for each of a plurality of stores (Stores 001-006). The cells of table 160 show the assortments offered by each of the stores during each of six different weeks (Week1-Week6). The items offered include items A, B, C, D, and E in various assortments. The cells of table 162 include available gross sales/customer traffic data (e.g., $200/200) for the corresponding cells of Table 160.

POS systems 110A-110N may store the data illustrated in tables 160 and 162, and may further transmit the data to computing system 120, which may be store the sales data as aggregate POS data 126. Under control of assortment optimization module 128, computing system 120 may group, or aggregate, the sales data for each unique assortment as illustrated in Tables 170 and 172. For example, Table 170 includes the aggregated sales data corresponding to assortment ABC. Table 172 includes the aggregated sales data corresponding to assortment ABCD.

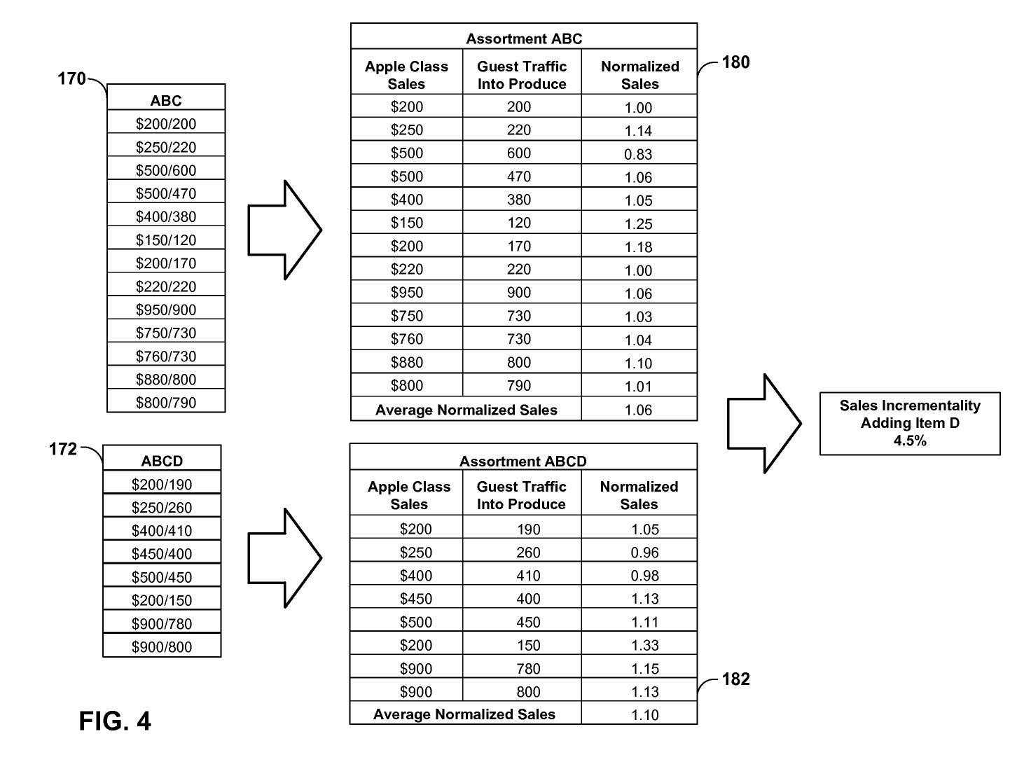

From the aggregated sales data, computing system 120 may determine an “average normalized sales” value for each unique assortment. The process of determining average normalized sales is described with respect FIG. 4. Tables 170 and 172 of FIG. 4 show the aggregated sales data from FIG. 3 for assortments ABC and ABCD, respectively. Computing system 120 may determine a normalized sales value for each store/week during which the assortment was offered. The normalized sales value normalizes the sales values on a per customer basis. For example, the first column of Tables 180 and 182 show the weekly sales for the corresponding store/week. The second column of Tables 180 and 182 show the customer traffic for the corresponding store/week. Thus, in this example, the first row of Table 180 shows that the weekly sales for Store 001, Week1, as $200, and the customer traffic as 200 customers. The third column of Tables 180 and 182 show the normalized sales value for the corresponding store/week. In this example, the normalized sales value is calculated by dividing the weekly sales by the weekly customer traffic. For example, in the first row of Table 180, the sales were $200 and the amount of guest traffic into the relevant product area was 200 customers, resulting in a normalized sales value of 1.00.

In some examples, de-seasonalization may also be considered when determining the normalized sales. De-seasonalization may help to allow for fair comparison of sales across different periods where sales are known to follow a seasonal pattern.

In this example, computing system 120 may further determine an averaged normalized sales value for assortments ABC and ABCD by averaging the normalized sales from the third columns of Tables 180 and table 182, respectively. For example, the average normalized sales value for the assortment ABC is 1.06, and the average normalized sales value for assortment ABCD is 1.10. Computing system 120 may also determine average normalized sales values for any other assortments for which sales data is available. For example, computing system 120 may also determine average normalized sales values for assortments ABCE, ABD, ABDE, and ABD as shown in Table 160 of FIG. 3.

The calculation of average normalized sales is but one approach that may be used. The average of the normalized sales is described herein for purposes of illustration. In other examples, the calculation may take into consideration the confidence in each observation and that eliminates outliers. Thus, it shall be understood that other approaches may be used in addition to or alternatively to the average normalized sales calculation described herein, and that the disclosure is not limited in this respect.

After determining the average normalized sales values for assortments ABC and ABCD, and similarly for the other assortments such as those shown in Table 160 of FIG. 3, computing system 120 may determine an estimated incrementality for one or more of the items in the assortments. For example, the possible varieties that could be included in an assortment are A, B, C, D, and E. Computing system 120 may estimate an incrementality of adding one or more of items A, B, C, D, and E to an assortment.

In FIG. 4, for example, computing system 120 may estimate the incrementality of adding item D to the assortment ABC based on the average normalized sales for assortment ABC, 1.06, and the average normalized sales for assortment ABCD, 1.10. In the example of FIG. 4, the estimated incrementality of adding item D to assortment ABC is 4.5%. The incrementality is estimated as the percentage of increase in sales due to the addition of one or more items to a specific assortment. In this example, the percentage may be calculated by dividing the difference between the normalized sales of the larger assortment to that of the original assortment divided by the normalized sales of the original assortment.

Once the estimated incrementalities are calculated, computing system 120 may check the estimated incrementalities against one or more incrementality sales volume rules. The incrementality sales volume rules may help to ensure that the estimated incrementalities follow certain assumptions about real world sales. The incrementality sales volume rules may include, for example, the following:
(1) The incrementality of adding an item to an assortment decreases as the number of items in the assortment increases.
(2) The incrementality of adding multiple items to an assortment increases as the number of items added increases.
(3) The incrementality of simultaneously adding multiple items to an assortment is less than the sum of the individual incrementalities of adding each of the items to the same assortment.
(4) The incrementality of simultaneously adding multiple items to an assortment is equal to the incrementality of adding each of the items separately to the same assortment.

For example, incrementality sales volume rule (1) is based on the assumption that adding an item to an assortment having a smaller number of items should have a greater impact on incremental sales than adding the same item to an assortment having a larger number of items.

The incrementality sales volume rules may include “strong” conditions and/or “weak” conditions. In one example, incrementality sales volume rules (1) and (4) may be considered strong conditions, while incrementality sales volume rules (2) and (3) may be considered weak conditions.

For example, strong conditions may be those conditions that are met regardless of other parameters, whereas weak conditions may be violated under extreme conditions (outliers). For example, it is possible to have lower sales (in terms of dollars) if a retailer adds a popular item at a very low price. This can shift demand from currently regular priced items to the newly introduced lower priced item, thus dragging the total sales of the larger assortment lower. Although retailers may generally try to avoid such scenarios in real-life, it is possible that theoretically and under generic scenarios such counter-intuitive results can happen. Thus, the example optimization model may impose all strong conditions first and may allow minor violation of weak conditions (when they happen) for a penalty.

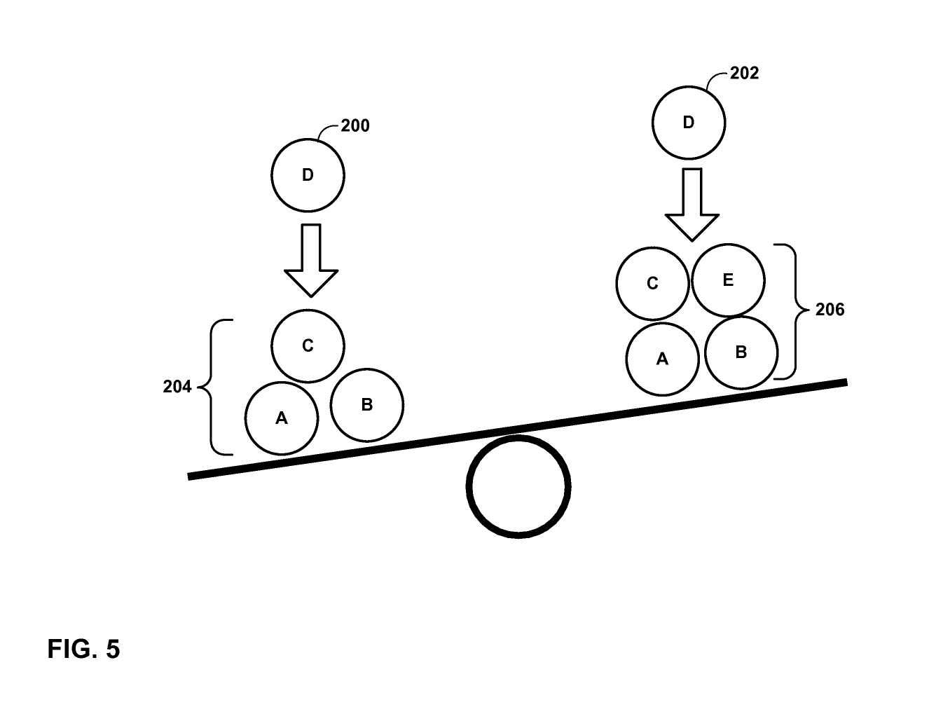

FIG. 5 is a conceptual diagram illustrating the first example incrementality sales volume rule. The balance shown in FIG. 5 illustrates that the incrementality of adding an item D (200) to an assortment of items ABC (204) is greater than adding the same item D (202) to an assortment of items ABCE (206). In other words, the incrementality of adding an item to an assortment decreases as the number of items in the assortment increases. Thus, the incrementality of adding item D to assortment ABC is greater than the incrementality of adding item D to assortment ABCE, because the number of items in the assortment ABCE is greater than the number of items in the assortment ABC. If the estimated incrementalities violate the rule illustrated in FIG. 5, computing system 120 may adjust one or more of the estimated incrementalities so that the rule is not violated.

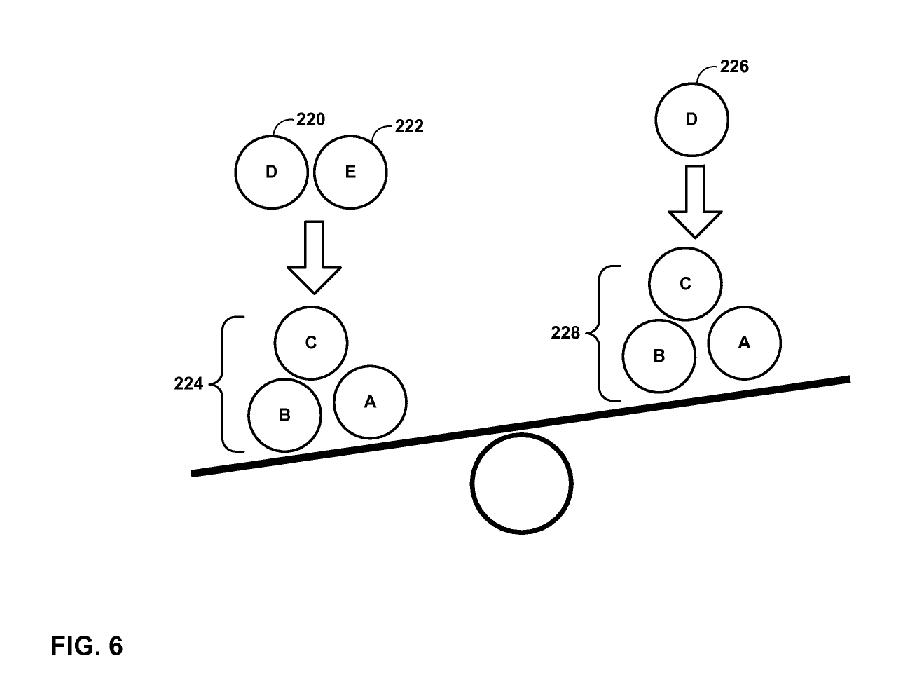

FIG. 6 is a conceptual diagram illustrating the second example incremental sales volume rule. The balance of FIG. 6 illustrates that the incrementality of simultaneously adding an item D (220) and an item E (222) to an assortment ABC (224) is greater than adding the single item D (226) to assortment ABC (228). In other words, the incrementality of adding items to an assortment increases as the number of items added increases. If the estimated incrementalities violate the rule illustrated in FIG. 6, computing system 120 may adjust one or more of the estimated incrementality so that the rule is not violated.

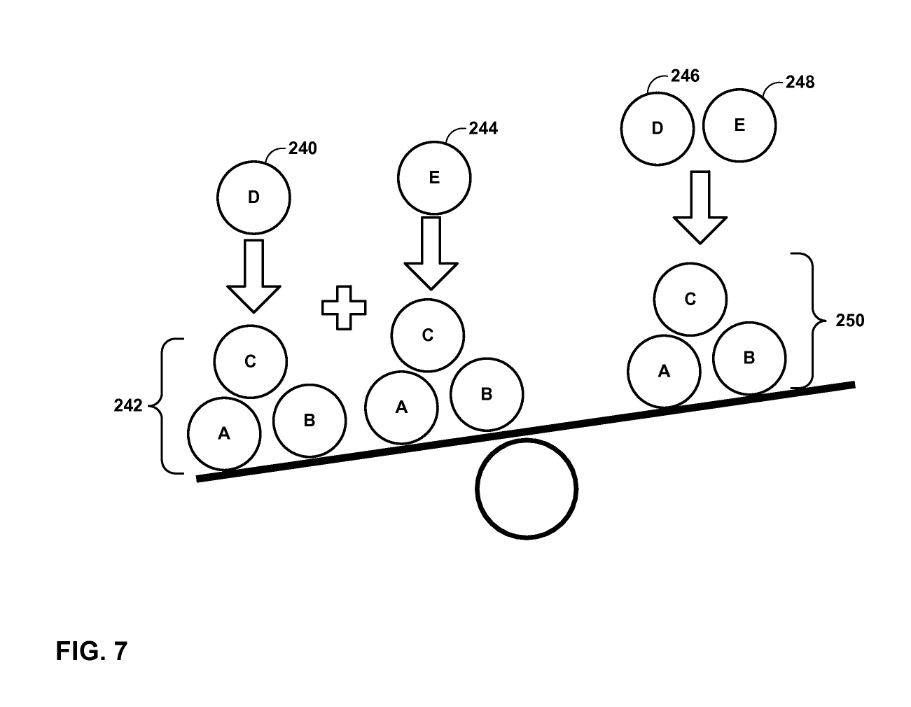

FIG. 7 is a conceptual diagram illustrating the third example incremental sales volume rule. The balance of FIG. 7 illustrates that the sum of the incrementality of adding a first item D (240) to an assortment ABC (242) and the incrementality of adding a second item E (244) to the assortment ABC (242) is greater than the incrementality of simultaneously adding first item D (246) and second item E (248) to the assortment ABC (250). In other words, the incrementality of adding multiple items to an assortment is less than the sum of the individual incrementalities of adding those items to the same assortment. If the estimated incrementalities violate the rule illustrated in FIG. 7, computing system 120 may adjust one or more of the estimated incrementalities so that the rule is not violated.

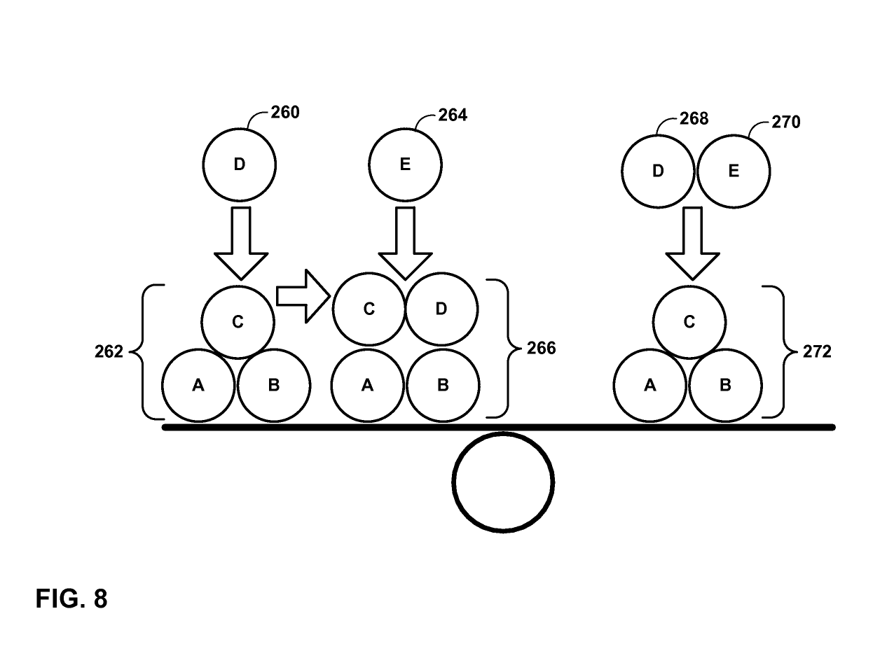

FIG. 8 is a conceptual diagram illustrating the fourth incremental sales volume rule. The balance of FIG. 8 illustrates that the incrementality of adding a first item D (260) to an assortment ABC (262), and then adding a second item E (264) to the resulting assortment ABCD (266) is equal to the incrementality of simultaneously adding first item D (268) and second item E (270) to the original assortment ABC (272). In other words, the incrementality of multiple items added simultaneously to an assortment is equal to the sequential addition of the same items to the same assortment. If the estimated incrementalities violate the rule illustrated in FIG. 8, computing system 120 may adjust one or more of the estimated incrementalities so that the rule is not violated.

For example, the optimization model may be a nonlinear program that has an objective function and multiple constraints. The constraints may cover all the variations of the conditions mentioned above. The model may work in a way such that each constraint tries to increase or decrease the originally estimated incrementalities to fit the conditions. On the other hand, the objective function may try to minimize the increases and decreases in the originally estimated incrementalities. In this way, only small changes may be made so that the conditions are not violated (otherwise the constraints could still be met while deviating largely from original estimates).

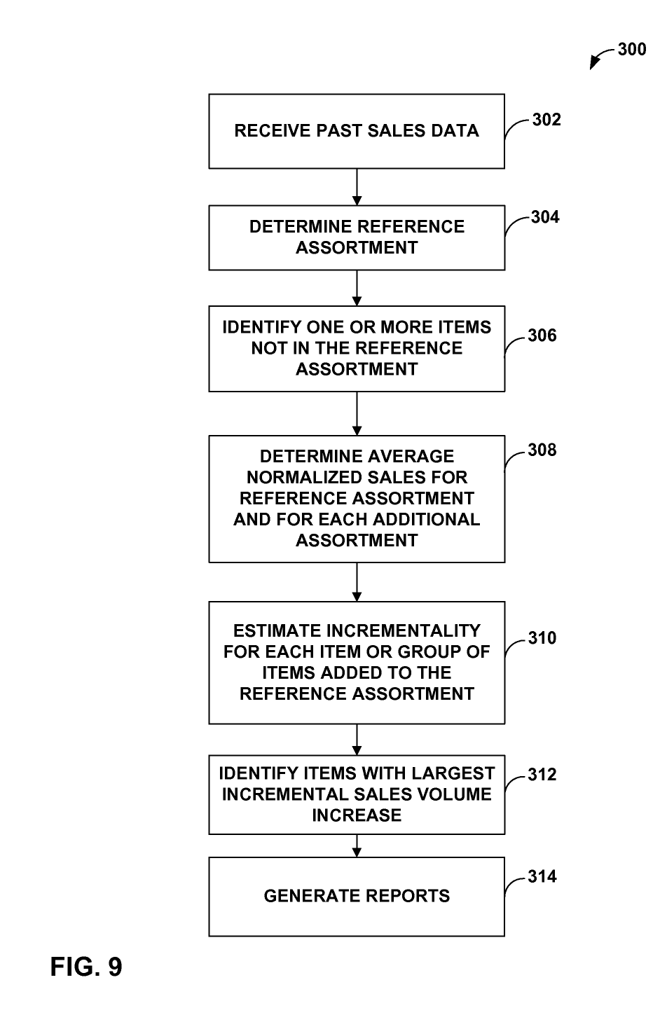

FIG. 9 is a flowchart illustrating an example process (300) for identifying one or more items that may result in the largest incremental sales volume increase for a product category. For purposes of illustration, the process (300) of FIG. 9 will be described as being performed by computing system 120 of FIG. 1; however, it shall be understood that example process (300) may be performed by any other suitable computing device(s), and that the disclosure is not limited in this respect.

In example process (300), computing system 120 receives past sales data for one or more assortments sold at a plurality of stores over a defined period of time (302). The sales data for the assortments shown in Tables 160 and 172 of FIG. 3 are one example of such sales data.

Based on the sales data, computing system 120 defines a reference assortment (304). The reference assortment may be used as a basis for calculation of the incrementalities of adding one or more items to the reference assortment. In FIGS. 5-8, for example, the reference assortment is the assortment including items ABC.

Computing system 120 identifies one or more items that are not included in the reference assortment (306). Computing system 120 calculates the average normalized sales for each assortment (308). The average normalized sales shown in Tables 180 and 182 of FIG. 4 are examples of such calculations.

Computing system 120 estimates one or more incrementalities for each of the identified items or groups of items added to the reference assortment (310). For example, this may include estimating the incrementality of adding an item D to a reference assortment ABC as shown in FIGS. 5 and 6, estimating the incrementality of adding an item D to an assortment ABCE as shown in FIG. 5, estimating the incrementality of adding an items D and E to reference assortment ABC as shown in FIGS. 6 and 7, estimating the sum of the incrementality of adding item D to reference assortment ABC and the incrementality of adding item E to reference assortment ABC as shown in FIG. 7, and/or estimating other incrementalities as may be applicable to the analysis.

During this step (310), computing system 120 may also test each of the incrementalities against one or more incremental sales volume rules. The incremental sales volume rules may include, for example, one or more of the incremental sales volume rules as discussed above, or other relevant rules. Computing system 120 may further adjust one or more of the incrementalities in the event that one or more of the incremental sales volume rules are violated.

Computing system 120 may identify one or more items having the largest estimated incremental sales volume increase for the category (312). The computing system 120 may further identify one or more items having the smallest estimated incremental sales volume increase, and/or rank one or more items or groups of items in terms of their estimated incremental sales volume increase. The computing system 120 may further generate reports (314) including one or more of the sales data, the estimated incrementalities associated with adding one or more items to the reference assortment, the item(s) with the largest incremental sales volume increase, the item(s) with a smallest incremental sales volume increase, and/or the ranking of one or more items in terms of their incremental sales volume increase. The reports may further include information and/or recommendations concerning which assortment(s) may result in largest estimated increase in total sales for the category, and/or rank one or more assortments in terms of their estimated total sales for the category.

Techniques described herein may be implemented, at least in part, in hardware, software, firmware, or any combination thereof. For example, various aspects of the described embodiments may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules, or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

Techniques described herein may also be embodied or encoded in an article of manufacture including a computer-readable storage medium and/or a computer-readable storage device encoded with instructions. Instructions embedded or encoded in an article of manufacture including an encoded computer-readable storage device, may cause one or more programmable processors, or other processors, to implement one or more of the techniques described herein, such as when instructions included or encoded in the computer-readable storage device are executed by the one or more processors. Computer-readable storage media and/or computer readable storage devices may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. Additional examples of computer readable medium include computer-readable storage devices, computer-readable memory, and tangible computer-readable medium. In some examples, an article of manufacture may comprise one or more computer-readable storage media.

In some examples, computer-readable storage media may comprise non-transitory media. The term “non-transitory” may indicate that the storage medium is tangible and is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
receiving, by a computing device, past sales data associated with a plurality of stores;
identifying a reference assortment including a first plurality of items;
identifying one or more additional items that are not included in the first plurality of items;
determining average sales for the reference assortment over a predetermined period of time based on the past sales data;
determining average sales for each of one or more new assortments over the predetermined period of time based on the past sales data, each new assortment including the first plurality of items and one or more of the additional items;
estimating an incremental sales volume increase associated with each of the one or more new assortments, each estimation based on the average sales for the reference assortment and the average sales for the associated new assortment;
identifying which of the one or more new assortments results in the largest incremental sales volume increase; and
generating one or more reports indicative of the identified new assortment that results in the largest incremental sales volume increase.

2. The method of claim 1 further including testing the estimated incremental sales volume increase associated with each of the one or more new assortments against one or more incremental sales volume rules.

3. The method of claim 2 wherein the one or more incremental sales volume rules are based on at least one of a number of items in the reference assortment, a number of additional items added to the reference assortment, and a sequence in which the one or more additional items are added to the reference assortment.

4. The method of claim 2, wherein adding a first item to a first assortment results in a larger incremental sales volume increase than adding the first item to a second assortment having a greater number of items than the first assortment.

5. The method of claim 2, wherein adding a first group of items to a first assortment results in a larger incremental sales volume increase than adding a second group of items to the first assortment if the second set of items is included within the first set of items.

6. The method of claim 2, wherein an incremental sales volume increase associated with simultaneously adding a plurality of items to a first assortment is less than a sum of the incremental sales volume increases associated with adding each of the plurality of items to the first assortment.

7. The method of claim 2, wherein an incremental sales volume increase associated with simultaneously adding multiple items to an assortment is equal to the incremental sales volume increase associated with adding each of the multiple items separately to the same assortment.

8. The method of claim 2 further including adjusting the estimated incremental sales volume increase if the estimated incremental sales volume increase violates one or more of the plurality of incremental sales volume rules.

9. The method of claim 1, wherein each estimated incremental sales volume increase is based on the average normalized sales for the reference assortment and the average normalized sales for the associated new assortment.

10. The method of claim 1, wherein generating one or more reports further includes generating a report including a ranking of the one or more new assortments in terms of the associated estimated incremental sales volume increase.

11. A device comprising:
a computer-readable storage medium;
at least one processor configured to access information stored on the computer-readable storage medium; and
an assortment optimization module stored on the computer-readable storage medium and accessible by the at least one processor, the assortment optimization module configured to:
receive past sales data associated with a plurality of stores;
identify a reference assortment including a first plurality of items;
identify one or more additional items that are not included in the first plurality of items;
determine average sales for the reference assortment over a predetermined period of time based on the past sales data;
determine average sales for each of one or more new assortments over the predetermined period of time based on the past sales data, each new assortment including the first plurality of items and one or more of the additional items;
estimate an incremental sales volume increase associated with each of the one or more new assortments, each estimation based on the average sales for the reference assortment and the average sales for the associated new assortment;
identify which of the one or more new assortments results in the largest incremental sales volume increase; and
generate one or more reports indicative of the identified new assortment that results in the largest incremental sales volume increase.

12. The device of claim 11 wherein the assortment optimization module is further configured to test the estimated incremental sales volume increase associated with each of the one or more new assortments against one or more incremental sales volume rules.

13. The device of claim 12 wherein the one or more incremental sales volume rules are based on at least one of a number of items in the reference assortment, a number of additional items added to the reference assortment, and a sequence in which the one or more additional items are added to the reference assortment.

14. The device of claim 12 wherein the assortment optimization module is further configured to adjust the estimated incremental sales volume increase if the estimated incremental sales volume increase violates one or more of the plurality of incremental sales volume rules.

15. The device of claim 11 wherein the assortment optimization module is further configured to estimate the incremental sales volume increase for each new assortment based on the average normalized sales for the reference assortment and the average normalized sales for the associated new assortment.

16. The device of claim 11 wherein the assortment optimization module is further configured to generate a report including a ranking of the one or more new assortments based on the associated estimated incremental sales volume increase.

17. A non-transitory computer-readable storage medium encoded with instructions that, when executed by one or more processors, cause the one or more processors of a computing device to:
receive, by a computing device, past sales data associated with a plurality of stores;
identify a reference assortment including a first plurality of items;
identify one or more additional items that are not included in the first plurality of items;
determine average sales for the reference assortment over a predetermined period of time based on the past sales data;
determine average sales for each of one or more new assortments over the predetermined period of time based on the past sales data, each new assortment including the first plurality of items and one or more of the additional items;
estimate an incremental sales volume increase associated with each of the one or more new assortments, each estimation based on the average sales for the reference assortment and the average sales for the associated new assortment;
identify which of the one or more new assortments results in the largest incremental sales volume increase; and
generate one or more reports indicative of the identified new assortment that results in the largest incremental sales volume increase.

18. The non-transitory computer-readable storage medium of claim 17 further encoded with instructions that, when executed by one or more processors, cause the one or more processors of a computing device to test the estimated incremental sales volume increase associated with each of the one or more new assortments against one or more incremental sales volume rules.

19. The non-transitory computer-readable storage medium of claim 18 wherein the one or more incremental sales volume rules are based on at least one of a number of items in the reference assortment, a number of additional items added to the reference assortment, and a sequence in which the one or more additional items are added to the reference assortment.

20. The non-transitory computer-readable storage medium of claim 17 further encoded with instructions that, when executed by one or more processors, cause the one or more processors of a computing device to generate a report including a ranking of the one or more new assortments based on the associated estimated incremental sales volume increase.
